(19) United States
(12) Patent Application Publication
(10) Pub. No.: US 2012/0242833 A1
(43) Pub. Date: Sep. 27, 2012

(54) EXTERIOR COMPONENT FOR VEHICLE

(75) Inventors: Wataru YAMAGUCHI, Anjo-shi (JP); Yukihide SHIBUTANI, Nagoya-shi (JP)

(73) Assignee: AISIN SEIKI KABUSHIKI KAISHA, Kariya-shi (JP)

(21) Appl. No.: 13/424,942

(22) Filed: Mar. 20, 2012

(30) Foreign Application Priority Data
Mar. 23, 2011 (JP) 2011-063584

(51) Int. Cl. H04N 7/18

(52) U.S. Cl. 348/148; 348/E07.085

(57) ABSTRACT

An exterior component for a vehicle includes a camera capturing an image of surroundings of a vehicle, and a through-hole at which the camera is provided. The through-hole forms an airflow to flow through the through-hole in association with a driving of the vehicle. The camera is provided at a position where the airflow flows and where an image capturing range serving as a function of the camera is ensured.

### CROSS REFERENCE TO RELATED APPLICATIONS

This application is based on and claims priority under 35 U.S.C. §119 to Japanese Patent Application 2011-063584, filed on Mar. 23, 2011, the entire content of which is incorporated herein by reference.

### TECHNICAL FIELD

This disclosure generally relates to an exterior component for a vehicle. More particularly, the disclosure pertains to an exterior component for a vehicle including a camera capturing an image of surroundings of the vehicle.

### BACKGROUND DISCUSSION

A known exterior component for a vehicle is disclosed in JP04-138943A (hereinafter referred to as Reference 1), for example. The exterior component disclosed in Reference 1 includes a camera incorporated in a center of a rear spoiler in a width direction of the vehicle so that the camera is positioned to face in a rear direction of the vehicle. A slit is formed at an upper side of the camera so as to penetrate through the rear spoiler. As a result, an airflow is formed by flowing from the slit when the vehicle is being driven, thereby reducing an attachment of raindrops and/or dust, for example, on a lens of the camera.

Another known exterior component for a vehicle is disclosed in JP2009-241749A (hereinafter referred to as Reference 2), for example. The exterior component disclosed in Reference 2 includes a camera capturing an image of surroundings of the vehicle, the camera being accommodated in an accommodation member. The accommodation member is attached at an exterior surface of the vehicle. The accommodation member is formed in a shape so that a rear end portion is gradually narrower. An opening portion is formed at the rear end portion of the accommodation member. The camera is provided at an inner side relative to the opening portion within the accommodation member. As a result, a disturbance of an airflow generated in the vicinity of the opening portion of the accommodation member when the vehicle is being driven is restrained, thereby decreasing an attachment of raindrops and/or dust, for example, on a lens of the camera.

According to the exterior component disclosed in Reference 1, because the airflow flowing from the slit is generated at the upper side of the camera, the attachment of raindrops and/or dust from a lower side of the camera may not be reduced.

In addition, according to the exterior component disclosed in Reference 2, the accommodation member is formed to be gradually narrower in the rear direction of the vehicle and the camera is arranged at the inner side relative to the opening portion within the accommodation member. Therefore, an image capturing range of the camera may decrease. Further, in order to mount the camera at the vehicle so as to capture the image of the surroundings of the vehicle, the accommodation member is additionally required. Because the accommodation member is provided at the exterior surface of the vehicle, a deterioration in design property of the vehicle may be inevitable.

A need thus exists for an exterior component for a vehicle which is not susceptible to the drawback mentioned above.

### SUMMARY

According to an aspect of this disclosure, an exterior component for a vehicle includes a camera capturing an image of surroundings of a vehicle, and a through-hole at which the camera is provided. The through-hole forms an airflow to flow through the through-hole in association with a driving of the vehicle. The camera is provided at a position where the airflow flows and where an image capturing range serving as a function of the camera is ensured.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a rear spoiler when the rear spoiler is viewed from a lower side according to an embodiment disclosed here;

FIG. 2 is a cross-sectional view taken along a line II-II in FIG. 1 illustrating an airflow flowing through surroundings of a vehicle and a through-hole of the rear spoiler; and

FIG. 3 is a perspective view illustrating details of the through-hole of the rear spoiler.

### DETAILED DESCRIPTION

An embodiment will be explained with reference to the attached drawings. In the embodiment, directions and orientations such as left, right, front, rear, upper, and lower correspond to those of a vehicle 100 where a rear spoiler 1 is provided.

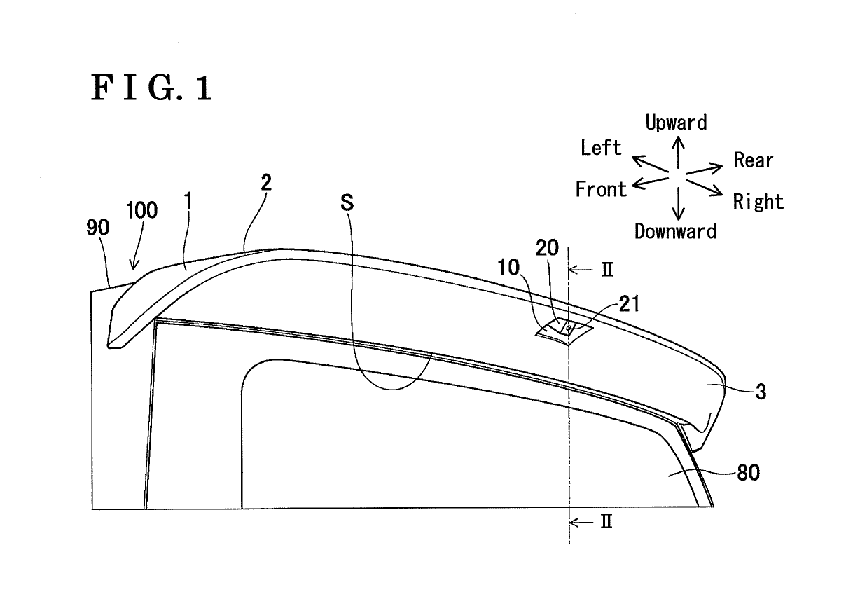

As illustrated in FIG. 1, the rear spoiler 1 serving as an exterior component for the vehicle 100 includes an upper wall portion 2, a lower wall portion 3, a through-hole 10, and a camera 20. The rear spoiler 1 is mounted to the vehicle 100 so as to increase a driving stability, a fuel consumption, and a design property of the vehicle 100, for example. The rear spoiler 1 is formed into a symmetrical shape in a width direction of the vehicle 100 while the upper wall portion 2 and the lower wall portion 3 extend in the width direction over an entire width of the vehicle 100. The through-hole 10 is substantially formed at a center of the rear spoiler 1 in the width direction of the vehicle 100. The camera20 is includes a lens 21 and the camera 20 is provided at the through-hole 10 so that a lens 21 of the camera 20 faces in a rearward direction of the vehicle 100. The rear spoiler 1 having the aforementioned configuration is mounted to an upper portion of a rear edge of a roof 90 so as to form a clearance S relative to a rear window 80.

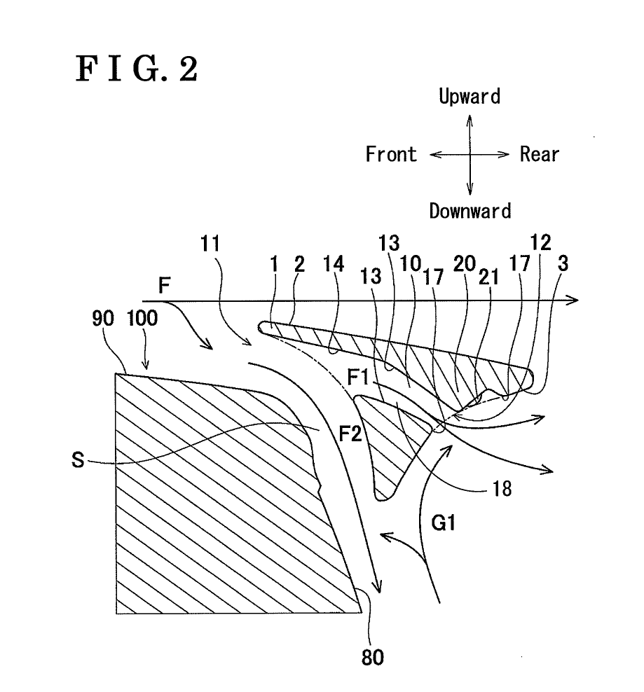

FIG. 2 explains an airflow F, a first airflow F1, and a second airflow F2 flowing through surroundings of the vehicle 100, the through-hole 10 of the rear spoiler 1, and the clearance S between the rear spoiler 1 and the rear window 80 respectively when the vehicle 100 is being driven. The first airflow F1 and the second airflow F2 each serve as an airflow. The through-hole 10 of the rear spoiler 1 includes an air intake port 11 and an air discharge port 12. The air intake port 11 is formed between the upper wall portion 2 of the rear spoiler 1 and the upper portion of the rear edge of the roof 90 while the air discharge port 12 is formed at the lower wall portion 3 of the rear spoiler 1. In addition, the through-hole 10 includes a fluid passage 18, through which the first airflow F1 flows, provided at a lower side of the camera 20. The clearance S is formed between the rear spoiler 1 and the rear window 80. The lens 21 of the camera 20 is positioned at a peripheral edge 17 of the air discharge port 12 and where an image capturing range of the camera 20 is inhibited from including an inner peripheral surface 13 of the through-hole 10. Further, the camera 20 is positioned at a first inner peripheral surface 14 of the through-hole 10 serving as an inner peripheral surface in a state where the lens 21 faces in the rearward direction of the vehicle 100. The first inner peripheral surface 14 is positioned at an upper side of the through-hole 10 in a height direction of the vehicle 100.

An airflow is generated around the vehicle 100 while the vehicle 100 is being driven forward (i.e., the forward driving of the vehicle 100). Specifically, the airflow F generated at an upper side of the vehicle 100 flows in the rearward direction of the vehicle 100. The first airflow F1 is a portion of the airflow F flowing through the through-hole 10 while the second airflow F2 is a portion of the airflow F flowing through the clearance S. The first airflow F1 flowing through the through-hole 10 is discharged from the air discharge port 12 so as to flow in the rear of the vehicle 100. The second airflow F2 flowing through the clearance S flows along the rear window 80 towards a lower side of the vehicle 100. In addition, when the vehicle 100 is driven on a rainy day or on a dirty road surface, for example, raindrops and/or dust, for example, flows towards the vehicle 100 from the rear of the vehicle 100.

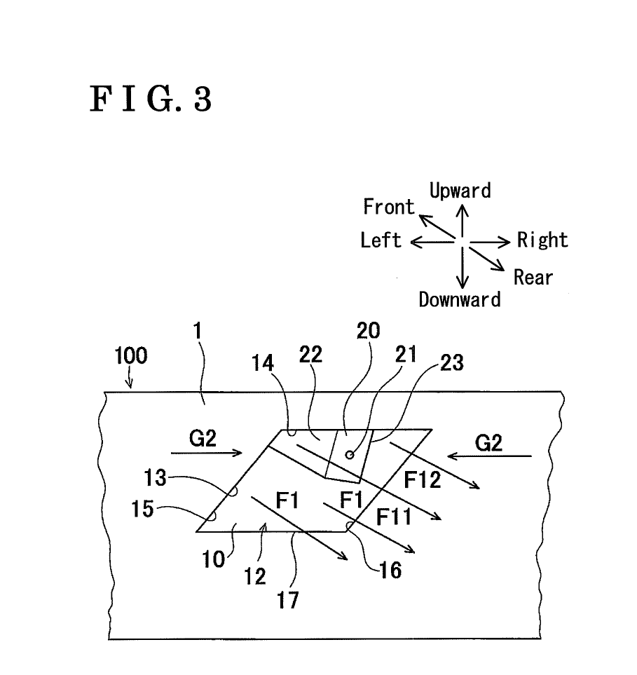

The first airflow F1 flows through the through-hole 10 in association with the driving of the vehicle 100. Specifically, the first airflow F1 flows through the lower side of the camera 20. As illustrated in FIG. 3, a first diversion airflow F11 and a second diversion airflow F12 are each obtained by a portion of the first airflow F1 split from the first airflow F1. The first diversion airflow F11 and the second diversion airflow F12 each serves as the airflow. The first diversion airflow F11 flows through a gap formed between a first end portion 22 of the camera and a second inner peripheral surface 15 of the through-hole 10 while the second diversion airflow F12 flows through a gap formed between a second end portion 23 of the camera 20 and a third inner peripheral surface 16 of the through-hole 10. The first end portion 22 and the second end portion 23 of the camera 20 face each other in a right and left direction (i.e., in the width direction) of the vehicle 100. The second inner peripheral surface 15 and the third inner peripheral surface 16 of the through-hole 10 also face each other in the right and left direction (in the width direction) of the vehicle 100.

The airflow generated at the through-hole 10 of the rear spoiler 1, the clearance S, and the surroundings of the vehicle 100 in association with the forward driving of the vehicle 100 will be explained with reference to FIGS. 2 and 3.

The airflow F, which is generated at the upper side of the roof 90 and of the upper wall portion 2 of the rear spoiler 1, flows in the rearward direction of the vehicle 100 along the roof 90 and the upper wall portion 2 of the rear spoiler 1. The first airflow F1 is obtained by the portion of the airflow F flowing from the air intake port 11 through the through-hole 10 so as to be discharged from the air discharge port 12. The first airflow F1 then flows to the rear side of the vehicle 100 along the lower wall portion 3 of the rear spoiler 1. A first adhesive material G1 such as raindrops and/or dust may be attached to the lens 21 of the camera 20 or the rear window 80 by flowing towards the camera 20 or the rear window 80 from the lower side of the vehicle 100. At this time, the first airflow F1 forms an air curtain in the rear of the camera 20 to thereby block the first adhesive material G1 from the lower side of the vehicle 100. In addition, the second airflow F2 forms an air curtain in the rear of the rear window 80 by flowing through the clearance S and flowing along the rear window 80 towards the rear side of the vehicle 100 to thereby block the first adhesive material G1 from adhering to the rear window 80.

As illustrated in FIG. 3, the first airflow F1, the first diversion airflow F11, and the second diversion airflow F12 flow through the through-hole 10 (specifically, the flow passage 18 of the through-hole 10) in association with the forward driving of the vehicle 100. At least one of the first diversion airflow F11 and the second diversion airflow F12 may flow around the camera 20 in the width direction of the vehicle 100. That is, the camera 20 may be provided at the first inner peripheral surface 14 of the through-hole 10 in a state where no gap is formed between the first end portion 22 of the camera 20 and the second inner peripheral surface 15 of the through-hole 10 or where no gap is formed between the second end portion 23 of the camera 20 and the third inner peripheral surface 16 of the through-hole 10. A second adhesive material G2 such as raindrops and/or dust may be attached to the lens 21 of the camera 20 by flowing from an outside of the through-hole 10 towards the camera 200 in the width direction of the vehicle 100. At this time, the first diversion airflow F11 and the second diversion airflow F12 each forms an air curtain around the camera 20 in the width direction to thereby block the second adhesive material G2 from adhering to the camera 20.

According to the rear spoiler 1 of the present embodiment, the camera 20 is positioned within the first airflow F1 that flows through the through-hole 10 in association with the forward driving of the vehicle 100 (i.e., the camera 20 is provided at the position where the first airflow F1 flows). Therefore, the first airflow F1 is formed at the lower side of the camera 20. As a result, in the rear of the vehicle 100, the first airflow F1 blocks the first adhesive material G1 that flows to the camera 20 from the lower side of the vehicle 100, thereby decreasing the attachment of raindrops and/or dust to the lens 21 of the camera 20. The lens 21 of the camera 20 is positioned to face the air discharge port 12 formed at the lower wall portion 3 of the rear spoiler 1. In this case, the upper wall portion 2 of the rear spoiler 1 blocks raindrops and/or dust from the upper side of the vehicle 100, which results in the decrease of the attachment of raindrops and/or dust to the lens 21 of the camera 20 from the upper side of the vehicle 100. In addition, the camera 20 is provided at the position so as to ensure the image capturing range serving as a function of the camera 20. Thus, an issue where the image capturing range is reduced because of the shape of the through-hole 10 or the position of the camera 20, for example, is resolved, Further, because the camera 20 is provided within the through-hole 10 of the rear spoiler 1, the design property of the vehicle 100 is ensured.

Furthermore, because the camera 20 is provided at the first inner peripheral surface 14 of the through-hole 10, the first airflow F1 is securely formed at the lower side of the camera 20. Thus, the first adhesive material G1 flowing towards the camera 20 from the lower side of the vehicle 100 is securely blocked by the first airflow F1, thereby providing the rear spoiler 1 that restrains the attachment of raindrops and/or dust to the lens 21 of the camera 20.

Furthermore, the first diversion airflow F11 is formed between the first end portion 22 of the camera 20 and the second inner peripheral surface 15 of the through-hole 10 while the second diversion airflow F12 is formed between the second end portion 23 of the camera 20 and the third inner peripheral surface 16 of the through-hole 10. Thus, the first diversion airflow F11 and the second diversion airflow F12 block the second adhesive material G2 flowing to the camera 20 from the outside of the vehicle 100 in the width direction. Therefore, the attachment of raindrops and/or dust flowing to the lens 21 of the camera 20 from the outside of the vehicle 100 in the width direction is reduced.

Furthermore, because the lens 21 of the camera 20 is positioned at the peripheral edge 17 of the air discharge port 12 of the through-hole 10, the image capturing range of the camera 20 is inhibited from including the inner peripheral surface 13 of the through-hole 10. Consequently, the image capturing range of the camera 20 is ensured.

According to the aforementioned embodiment, the through-hole 10 and the camera 20 constitute a portion of the rear spoiler 1. Alternatively, the through-hole 10 and the camera 20 may constitute a portion of a trunk, a fender, a side mirror, or a bumper, for example.

According to the rear spoiler 1 of the present embodiment, the camera 20 is positioned within the first airflow F1 that flows through the through-hole 10 in association with the driving of the vehicle 100. Therefore, the first airflow F1 is formed at the lower side of the camera 20 in the height direction of the vehicle 100. As a result, in the rear of the vehicle 100, the first airflow F1 blocks raindrops and/or dust that flows to the camera 20 from the lower side of the vehicle 100, thereby decreasing the attachment of raindrops and/or dust to the lens 21 of the camera 20. In addition, the camera 20 is provided at the position so as to ensure the image capturing range serving as the function of the camera 20. Thus, an issue where the image capturing range is reduced because of the shape of the through-hole 10 or the position of the camera 20, for example, is resolved. Further, because the camera 20 is provided within the through-hole 10 of the rear spoiler 1, the design property of the vehicle 100 is ensured.

According to the aforementioned embodiment, the through-hole 10 is formed at the lower side of the camera 2, the through-hole 10 including the flow passage 18 where the first airflow F1 flows.

Accordingly, in the rear of the vehicle 100, the first airflow F1 blocks raindrops and/or dust that flows to the camera 20 from the lower side of the vehicle 100, thereby decreasing the attachment of raindrops and/or dust to the lens 21 of the camera 20.

According to the aforementioned embodiment, the camera 2 is provided at the first inner peripheral surface 14 formed at the upper side of the through-hole 10 in the height direction of the vehicle 100.

Accordingly, the first airflow F1 is securely formed at the lower side of the camera 20. Thus, raindrops and/or dust flowing towards the camera 20 from the lower side of the vehicle 100 is securely blocked by the first airflow F1, thereby providing the rear spoiler 1 that further reduces the attachment of raindrops and/or dirt to the lens 21 of the camera 20.

According to the aforementioned embodiment, the through-hole 10 forms the first diversion airflow F11 and/or the second diversion airflow F12 flowing through respective sides or either side of the camera 20 in the width direction of the vehicle 100.

Accordingly, the raindrops and/or dust flowing to the camera 20 from the outside of the vehicle 100 in the width direction of the vehicle 100 are blocked. Therefore, the attachment of raindrops and/or dust flowing to the lens 21 of the camera 20 from the outside of the vehicle 100 in the width direction is reduced.

Accordingly, the image capturing range of the camera 20 is inhibited from including the inner peripheral surface 13 of the through-hole 10. Consequently, the image capturing range of the camera 20 is ensured.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An exterior component for a vehicle, comprising:
a camera capturing an image of surroundings of a vehicle; and
a through-hole at which the camera is provided;
the through-hole forming an airflow to flow through the through-hole in association with a driving of the vehicle,
the camera being provided at a position where the airflow flows and where an image capturing range serving as a function of the camera is ensured.

2. The exterior component according to claim 1, wherein the through-hole is formed at a lower side of the camera, the through-hole including a flow passage where the airflow flows.

3. The exterior component according to claim 1, wherein the camera is provided at an inner peripheral surface formed at an upper side of the through-hole in a height direction of the vehicle.

4. The exterior component according to claim 1, wherein the through-hole forms the airflow flowing through respective sides or either side of the camera in a width direction of the vehicle.

5. The exterior component according to claim 1, wherein the camera includes a lens and the lens is positioned at a peripheral edge of an air discharge port from which the airflow formed by the through-hole is discharged.
